(19) United States
(12) Patent Application Publication
(10) Pub. No.: US 2007/0025654 A1
(43) Pub. Date: Feb. 1, 2007

(54) Tapered roller bearing assembly and method of fabricating the same

(75) Inventor: Yoshifumi Shige, Nara (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Koyo Seiko Co., Ltd., Osaka (JP)

(21) Appl. No.: 11/188,640

(22) Filed: Jul. 26, 2005

(51) Int. Cl. F16C 32/00; F16C 41/04; F16C 33/48

(52) U.S. Cl. 384/448

(57) ABSTRACT

A tapered roller bearing assembly includes: an outer race that includes first and second outer race side raceway surfaces; an inner shaft that is inserted into the outer race, and includes a small diameter portion at an axial end thereof, a first inner race side raceway surface which has a diameter larger than that of the small diameter portion, and an intermediate cylindrical surface which is formed between the small diameter portion and the first inner race side raceway surface and has substantially the same diameter as that of the first inner race side raceway surface; an inner race fitted to the small diameter portion and including a second inner race side raceway surface; a plurality of tapered rollers interposed between the first outer race side raceway surface and the first inner race side raceway surface and between the second outer race side raceway surface and the second inner race side raceway surface; and a pulser ring fitted to the intermediate cylindrical surface.

### BACKGROUND OF THE INVENTION

The present invention relates to a tapered roller bearing assembly-and a method of fabricating the same.

A tapered roller bearing assembly for rotatably supporting a wheel relative to a vehicle body is known (refer to JP-A-2000-94902). This tapered roller bearing assembly includes, as shown in FIG. 5, an outer race 51, an inner shaft 52 as a first inner race member, an inner race as a second inner race member, a plurality of tapered rollers 54 and two cages 55, 56 for retaining the tapered rollers 54 to be equally spaced apart in. P circumference direction and is made into a type of dual-row tapered roller bearing assembly.

An attachment portion 57 for attachment to the vehicle body is provided on the outer race 51 in such a manner as to erect radially outward. An attachment portion 58 for attachment to a wheel is provided on the inner race at a position thereof which is further outward (right side in FIG. 5) in a axial direction of the vehicle than the outer race 51 in such a manner as to erect radially outward. A tapered inner race side raceway surface 59 is provided on the inner shaft 52 at a position thereof which is further inward (left side in FIG. 5) in the axial direction of the vehicle than the attachment portion 58 for attachment to a wheel in such a manner that the tapered rollers 54 roll thereon. Flange portions 59a, 59b are provided on both sides of the inner race side raceway surface 59.

As has been described above, the tapered roller bearing assembly described in JP-A-2000-94902 includes a thick or raised portion at a portion on a small diameter side of the inner race side raceway surface 59 of the inner shaft 52 due to the provision of the flange portion 59b. This raised portion constitutes a barrier when attempting to fit an assembly in which the tapered rollers 54 and the cage 55 are assembled in advance on the inner shaft 52.

In contrast to this, a tapered roller bearing assembly is known in which, of the flange portions 59a, 59b which are provided on both the sides of the inner race side raceway surface 59 on the inner shaft 52, the flange portion 59b on the small diameter side is omitted so as to eliminate the raised portion on the small diameter side of the inner race side raceway surface 59. In this construction, the tapered rollers 54 and the seal 60 are set in advance on the outer race 51, and the outer race 51 may be moved in an axial direction relatively to the inner shaft 52 to which the tapered rollers 54 and the inner race 53 are not attached for fitting thereon. In this case, the tapered rollers 54 set on the outer race 51 are disposed on the inner race side-raceway surface 59 on the inner shaft 52 without being caught.

However, a stable assembled state cannot be provided only by fitting the outer race 51, on which the tapered rollers 54 and the seal 60 are set, on the outer circumference of the inner shaft 52. Hence, in the event that the bearing assembly is inclined or lifted for some reason, there may be caused a risk that the tapered rollers 54 and the like are allowed to come out of the outer race 51 to be scattered, whereby the assembled state is disassembled. In addition, when attempting to reassemble the disassembled components, there may also be caused a risk that a lip provided at a tip of the seal 60 is struck against the tapered rollers 54, whereby the tapered rollers may be turned over.

### SUMMARY OF THE INVENTION

The invention was made in view of the conventional problem that has been described above, and a problem that the invention is to solve is how to ensure and facilitate the proper fabricating work by preventing the relevant members from being disassembled in the middle of fabrication.

In order to solve the problem, according to the invention, there is provided a tapered roller bearing assembly having an outer race having an attachment portion for attachment to a vehicle body on a radially outer side portion and a plurality of rows of outer race side raceway surfaces on a radially inner side portion thereof, an inner shaft which is adapted to be concentrically inserted in a radially inner side of the outer race, which has a small diameter portion at an axial end thereof, in which an inner race side raceway surface, which is to make a pair together with one of the outer race side raceway surfaces of the outer race, is formed on a radially outer side portion at the other axial end thereof, and which has an attachment portion for attachment to a wheel on a radially outer side portion thereof at a position which is further axially outward than the inner race side raceway surface, an inner race which is adapted to be fitted on an outer circumference of the small diameter portion of the inner shaft and which has on a radially outer side portion thereof an inner race side raceway surface which is to make a pair together with the other outer race side raceway surface of the outer race, and a plurality of tapered rollers which are interposed between the one of the outer race side raceway surfaces of the outer race and the inner race side raceway surface of the inner shaft, and between the other outer race side raceway surface of the outer race and the inner race side raceway surface of the inner race, wherein an intermediate cylindrical surface is formed on the inner race side raceway surface of the inner shaft and the small diameter portion, and a rotation detecting pulsar ring is securely fitted on and fixed to an outer circumference of the intermediate cylindrical surface.

The tapered roller bearing assembly that is configured as has been described above is fabricated through a first step of disposing the tapered rollers on the one of the outer race side raceway surfaces of the outer race, a second step of fitting the outer race on which the tapered rollers are attached on the inner shaft to which no other member such as the inner race has not yet been attached, a third step of press fitting the pulsar ring on the outer circumference of the intermediate cylindrical surface of the inner shaft, and a fourth step of disposing the tapered rollers on the inner race side raceway surface of the inner race and fitting the inner race on which the tapered rollers are attached on the outer circumference of the small diameter portion of the inner shaft, so that the inner race is fixed on to the inner shaft.

In the middle of the fabricating process, the pulsar ring that is securely fitted on the outer circumference of the intermediate cylindrical surface functions as a means for preventing the tapered rollers and the cage thereof from slipping out, whereby the separation of the tapered rollers, the outer race and the like is prevented.

Note that it goes without saying that the pulsar ring cooperates with a sensor, which is provided on the outer race in such a manner as to face the pulsar ring, in detecting the rotation of an axle inserted in the inner shaft or a central hole therein. While the seal, which protrudes radially inward, is normally attached to the radially inner side portion of the end portion of-the outer race which faces the wheel in the middle of fabrication, another type of seal, for example, a type of seal that is to be attached to a radially outer side of the end portion of the outer race may be used at the end portion of the outer race which faces the wheel.

### BRIEF DESCRIPTION OF THE DRAWINGS

FIG. 1 is a longitudinal sectional view of a tapered roller bearing assembly according to an embodiment of the invention.

FIG. 2 is a longitudinal sectional view of a half portion of the tapered roller bearing assembly shown in FIG. 1 which shows a step of a fabrication process of the bearing assembly.

FIG. 3 is a longitudinal sectional view of the half portion of the tapered roller bearing assembly shown in FIG. 1 which shows a step following the step shown in FIG. 2.

FIG. 4 is a longitudinal sectional view of the half portion of the tapered roller bearing assembly shown in FIG. 1 which shows a step following the step shown in FIG. 3.

FIG. 5 is a longitudinal sectional view of a half portion of a conventional tapered roller bearing assembly.

### DETAILED DESCRIPTION OF PREFERRED EMBODIMENTS

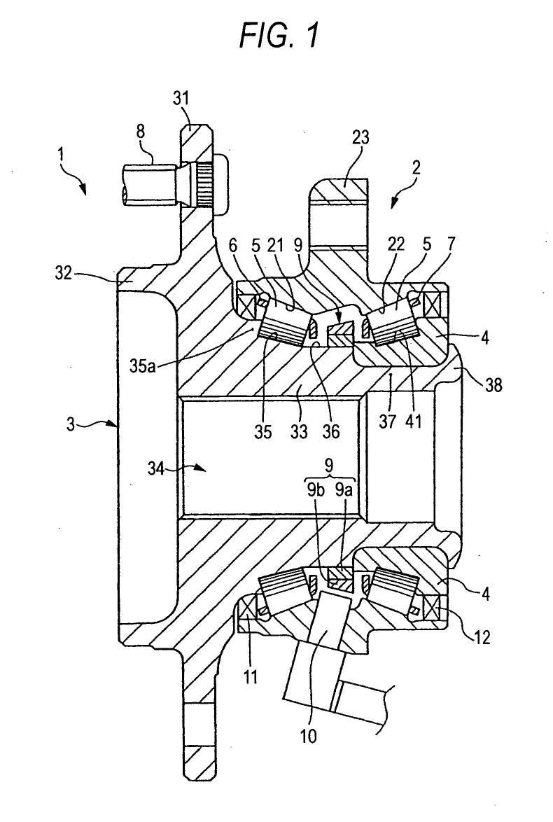

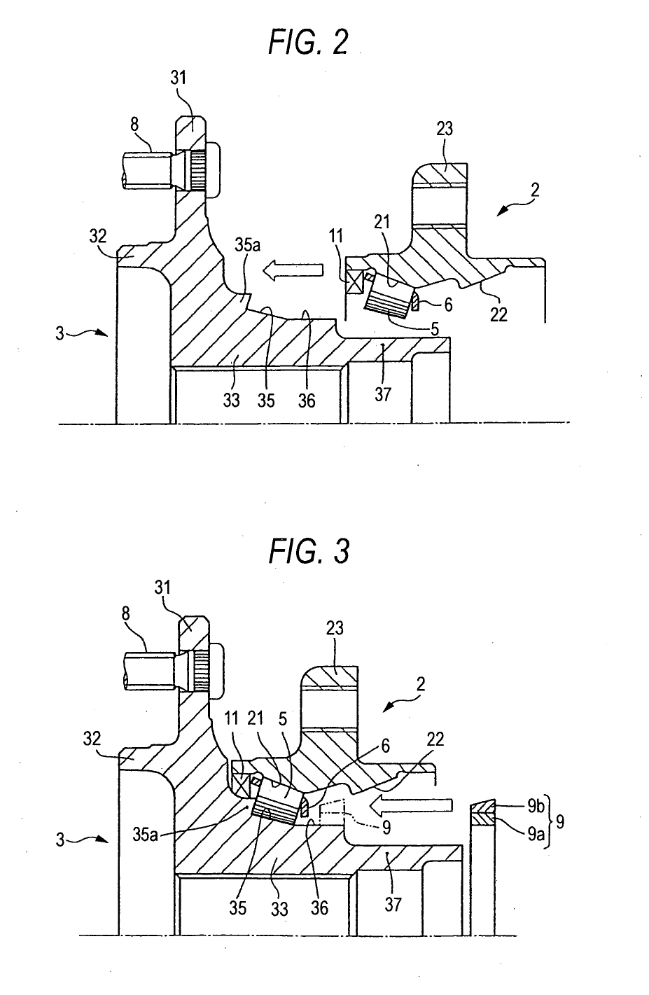

FIGS. 1 to 4 show as embodiment of the invention, in which FIG. 1 is a longitudinally sectional view of a tapered roller bearing assembly according to an embodiment of the invention, and FIGS. 2 to 4 are longitudinally sectional views of a half portion of the wheel bearing assembly shown in FIG. 1, which show steps of fabricating the assembly, respectively. A tapered roller bearing assembly 1 illustrated in the figures is a tapered roller bearing assembly for a driving wheel and is made into a type of double-row tapered roller bearing assembly which includes an outer race 2, an inner shaft 3 as a first inner race member, an inner race 4 as a second inner race member, a plurality of tapered rollers 5 and two cages 6, 7.

The outer race 2 includes two tapered outer race side raceway surfaces 21, 22 provided adjacent to each other in an axial direction thereof on a radially inner side portion thereof and an attachment portion 23 provided on a radially outer side portion thereof in such a manner as to erect radially outward therefrom. This attachment portion 23 is fixed to a carrier or knuckle which constitutes part of the vehicle body with a bolt, not shown, in such a manner as not to rotate. Of the two outer race side raceway surfaces 21, 22, the outer race side raceway surface 21 which is situated further outward of the vehicle (left-hand side as viewed in FIG. 1) is inclined in such a manner as to gradually increase in diameter toward the outside of the vehicle, whereas the outer race side raceway surface 22 which is situated further inward of the vehicle (right-hand side as viewed in FIG. 1) is inclined in such a manner as to gradually increase in diameter toward the inside of the vehicle.

The inner shaft 3 includes an attachment portion 31 which erects at a position further outward than the outer race 21 and which erects radially outward, a cylindrical spigot joint portion 32 which is provided further axially outward than the attachment portion 31 and a shaft portion 33 which is provided further transversely inward than the attachment portion 31. Although not shown, a wheel and a brake disc rotor are attached to the attachment portion 31 and the cylindrical spigot joint portion 32. An axle, not shown, is spline fitted in a center hole 34 provided in the center of the inner shaft 3. Note that reference numeral 8 denotes a fixing bolt for a wheel which is fixedly press fitted in a hole in the attachment portion 31.

The inner shaft 3 includes a tapered inner race side raceway surface 35, an intermediate cylindrical surface 36 and a small diameter portion 37 which are provided in that order on a radially outer side portion thereof from its attachment portion 31 side in an axially inward direction of the vehicle. The inner race side raceway surface 35 is a raceway surface which makes a pair together with the outer race side raceway surface 21 on the outer race 2 which is situated outward in the axial direction of the vehicle. While a flange portion (a large flange portion ) 35a is provided at one of side portions of the inner race side raceway surface 35 which is situated on a large diameter side thereof, a flange portion is omitted at the other portion of the raceway surface 35 which is situated on a small diameter side thereof. Then, the small diameter-side portion of the inner race side raceway surface 35 directly continues to the intermediate cylindrical surface 36 via neither a raised portion nor a stepped portion. Consequently, the intermediate cylindrical surface 36 has substantially the same diameter as that of the small diameter-side portion of the inner race side raceway surface 35. This intermediate cylindrical surface 36 continues to a stepped portion of the border of the small diameter portion 37 in the axial direction.

A pulsar ring 9 for detecting rotation is securely fitted on an outer circumference of the intermediate cylindrical surface 36 via press fit. The pulsar ring 9 detects the rotation of the inner shaft 3 or a wheel which is attached to the inner shaft with cooperation with the a corresponding sensor 10. In this embodiment, the pulsar ring 9 is made up of a magnet type pulsar ring in which an annular magnet 9b having magnetic poles arranged alternately in a circumferential direction is attached to a metallic support ring 9a. A magnetic piece type pulsar ring, which is made up of a comb-like metallic annular ring or a metallic ring having through holes provided at several circumferential locations thereof, may be used for the pulsar ring 9. An outer circumferential surface of the pulsar ring 9 is inclined in the axially outward direction of the vehicle. The sensor 10 corresponding to the pulsar ring 9 is provided in such a manner as to penetrate from the outer periphery to the inner periphery of the outer race 2. This sensor 10 is attached in an inclined posture in the axially outward direction of the vehicle so as to correspond to the inclination of the outer circumferential surface of the pulsar ring 9, and a detecting surface at a distal end thereof is positioned close to the outer circumferential surface of the pulsar ring 9 in a face-to-face fashion.

The inner race 4 includes a tapered inner race side raceway surface 41 provided on an outer circumference thereof. This inner race side raceway surface 41 is such as to make a pair together with the outer race side raceway surface 22 of the outer race 2 which is positioned inward in the axial direction. The inner race 4 is fitted on the small diameter portion 37 of the inner shaft 3 and is fixed in place by a clamping portion 38. Note that an axially inner end of the inner race 4 is made slightly larger in diameter than the intermediate cylindrical surface 36 of the inner shaft 3 so as to form a step between the intermediate cylindrical surface 36 and itself, and the step contact with the inner side end surface of the pulsar ring 9.

The tapered rollers 5 are interposed, respectively, between the outer race side raceway surface 21 of the outer race 2 which is positioned axially outward and the inner race side raceway surface 35 of the inner shaft 4 and between the outer race side raceway surface 22 of the outer race 2 which is positioned axially inward and the inner race side raceway surface 41 of the inner race 4. The cages 6, 7 in which a plurality of pocket portions for retaining the tapered roller 5 are formed equally spaced each other in the circumferential direction are such as to hold the two rows of tapered rollers 5 to be disposed circumferentially at equal intervals, respectively.

Seals 11, 12 are securely attached to axial ends of the outer race 2 in such a manner as to protrude radially inward. Lip portions which contact outer circumferential surfaces of the inner shaft 3 and the inner race 4, respectively, are provided at tips of the seals 11, 12 in the radially inner side, respectively. Grease not shown is charged in an annular space defined by the seals 11, 12 therebetween where the tapered rollers 5 are accommodated.

The tapered roller bearing assembly 1 constructed as described above supports a wheel rotatably relative to the vehicle body when the attachment portion 23 on the outer race 2 is attached to part of the vehicle body, the axle is fitted in the center hole 34 in the inner shaft 3 and the wheel is attached to the attachment portion 31. In the interior of the tapered roller bearing assembly 1, the rotational speed of the wheel is detected by rotating the pulsar ring 9 relative to the sensor 10.

Next, based on FIGS. 2 to 4, a method for fabricating the tapered roller bearing assembly 1 that is configured as described heretofore will be described. Note that in FIGS. 2 to 4, while the axial direction is shown as extending horizontally for the sake of attaining easy understanding in relation to FIG. 1, in an actual fabricating process, fabrication is normally implemented in a vertical posture in which the attachment portion 31 of the inner shaft 3 faces downward and the small diameter portion 37 of the inner shaft 3 faces upward.

(1) First Step

As shown in FIG. 2, the tapered rollers 5 are disposed on the outer race side raceway surface 21 of the outer race 2 which is positioned axially outward together with the cage 6, and the seal 11 is attached to the radially inner side portion of the end portion of the outer race 2 which is located axially outward. On the other hand, the inner shaft 3 remains in such a bare state that members such as the tapered rollers 5 and the inner race 4 are not attached thereto. The end portion of the inner shaft 3 which is located axially inward is in a state before clamping work is applied thereto, and extends in the axially inward direction of the vehicle while the diameter of the end portion is the same diameter as that of the small diameter portion 37.

(2) Second Step

A second step is a step in which, as shown in FIG. 2, the outer race 2, in which the tapered rollers 5 with the cage 6 and the seal 11 are set on the radially inner side thereof, is moved axially relative to the inner shaft 3, to which other members such as the inner race 4 and the like are not attached, so that the outer race 2 is concentrically fitted on the inner shaft 3. The tapered rollers 5 are allowed to be interposed between the inner race side raceway surface 35 of the inner shaft 3 and the outer race side raceway surface 21 of the outer race 2 which is positioned axially outward through this step.

In this case, since the inner race side raceway surface 35 of the inner shaft 3 continues to the intermediate cylindrical surface 36 and there exists no raised portion such as a flange portion which rises radially outward therebetween, the tapered rollers 5 set on the outer race 2 are allowed to move in the axial direction on the radially outer side of the inner shaft 3 to thereby disposed on the outer circumference of the inner race side raceway surface 35 of the inner shaft 3 as shown in FIG. 3. Similarly, the seal 11 is also allowed to move in the axial direction thereby be brought into contact with a predetermined position on the radially outer side portion of the inner shaft 3.

(3) Third Step

The fabricated state as shown in FIG. 3 is not stabilized only by fitting the outer race 2 on the outer circumference of the shaft portion 33 of the inner shaft 3 so that the tapered rollers 5 and the seal 11 are provided in place therebetween. If the inner shaft 3 is inclined or lifted up for some reason, there may cause a risk that the tapered rollers 5 and the seal 11 are slipped out from the inner shaft 3, whereby the whole of the-bearing assembly so fabricated may disassembled.

Then, to cope with this, in this step, the pulsar ring 9 is fitted on the outer circumference of the intermediate cylindrical surface 36 of the inner shaft 3 via press fit so that the pulsar ring 9 is fixed on to the intermediate cylindrical surface 36. Since the pulsar ring 9 is situated further axially inward and protrudes further radially outward than the tapered rollers 5 which have already been interposed between the inner shaft 3 and the outer race 2, the pulsar ring 9 can prevent the tapered rollers 5 and the cage 6 from slipping toward the vehicle inner side. In the case that the tapered rollers 5 is prevented from axially slipping out, the outer race 2 which includes the seal 11 which can interfere with the tapered rollers 5 in the axial direction is also prevented from slipping out. Thus, the risk is eliminated that the outer race 2 and the tapered rollers 5 which are assembled to the inner shaft 3 are separated.

(4) Fourth Step

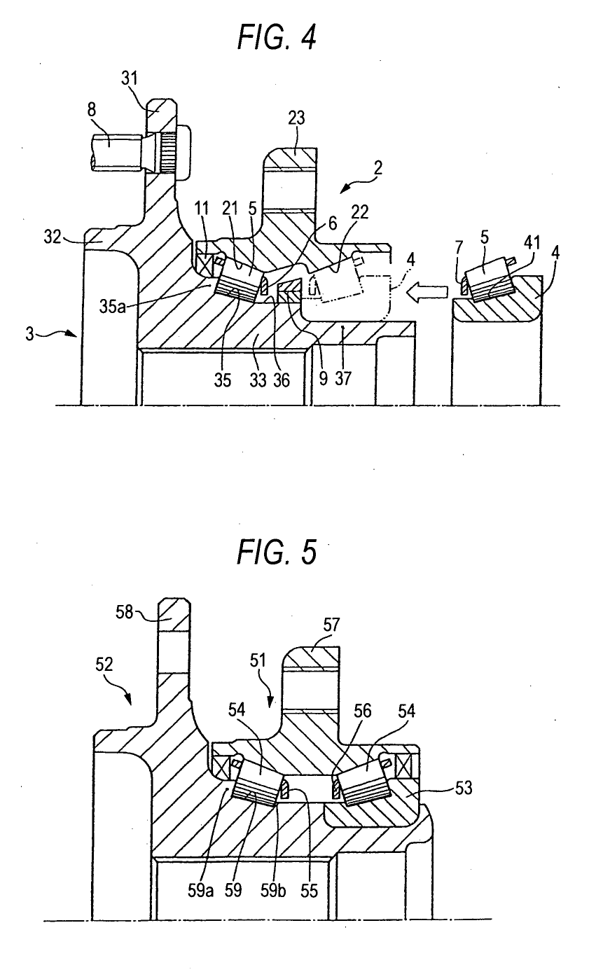

In this step, firstly, as shown in FIG. 4, the plurality of tapered rollers 5 are disposed on the inner race side raceway surface 41 of the inter race 4 together with the cage 7. Then, the inner race 4 to which the tapered rollers 5 are attached is fitted on the outer circumference of the small diameter portion 37 of the inner shaft 3, whereby the tapered rollers 5 are allowed to be interposed between the inner race side raceway surface 41 of the inner race 4 and the outer race side raceway surface 22 of the outer race 2 which is positioned axially inward. Thereafter, the inner race 4 is fixed to the small diameter portion 37 of the inner shaft 3 by clamping an end portion of the small diameter portion 37 radially outward. Furthermore, the seal 12 (not shown in FIG. 4) is securely attached between a vehicle inner side end portion of the inner race and the end portion of the outer race 2 which corresponds thereto, whereby the tapered roller bearing assembly 1 shown in FIG. 1 is completed.

Although, in the embodiment that has been described heretofore, the protruding seal 11 is attached to the radially inner side of the end portion of the outer race 2 which is located axially outward, the seal to be attached to the outer race 2 is not limited thereto, and a type of seal to be attached to a radially outer side of the end portion of the outer race 2 may be used. In addition, although, in the embodiment, the invention is described as being applied to the tapered roller bearing assembly for a driving wheel, the invention can be applied to a tapered roller bearing assembly for a driven wheel.

Although, in the embodiment, the outer circumferential surface of the pulsar ring 9 and the detecting surface of the sensor 10 are made to face each other in such a state that the surfaces are inclined in the transversely outward direction of the vehicle, the invention is not limited thereto, and the two surfaces may be made to face each other in a horizontal state without being inclined.

Further, although, in the embodiment, the inner race 4 is fixed to the small diameter portion 37 of the inner shaft 3 by the clamping portion 38, the method for fixing the inner race 2 to the small diameter portion 37 of the inner shaft 3 in such a manner as not to move axially is not limited thereto, and the axle which is inserted into the center hole 34 in the inner shaft 3 may be used. That is, a nut which is screwed on a threaded portion formed at a vehicle outer side axial end of the axle and is abutted to the vehicle outer side end surface of the inner shaft 3 holds the inner shaft 3 and the inner race 4 in cooperation with a step which is formed at the outer periphery of the axle and is abutted to the inner side end surface of the inner race 4, thereby the inner race 4 is fixed to the smaller diameter portion 37 of the inner shaft 3.

According to the invention, the separation of the relevant constituent members in the middle of fabrication can be prevented, and hence the fabrication of the tapered roller bearing assembly can be facilitated without any problem. In addition, since there is no risk that the constituent members are disassembled, the turning over of the seal lip portion in association with reassembly of the members does not occur.

According to the present invention, since the pulsar ring for detecting rotation is provided for preventing the separation of the members, no additional member for preventing the separation of the members needs to be prepared, the invention can be implemented at low costs without calling for an increase in cost.

What is claimed is:

1. A tapered roller bearing assembly comprising:
an outer race that includes an attachment portion for attachment of a vehicle body on a radially outer side portion thereof and first and second outer race side raceway surfaces on a radially inner side portion thereof;
an inner shaft that is to be concentrically inserted into the outer race, and includes a small diameter portion at an axial end thereof, a first inner race side raceway surface which is opposed to the first outer race side raceway surface, an intermediate cylindrical surface which is formed between the small diameter portion and the first inner race side raceway surface, and an attachment portion for attachment of a wheel on a radially outer side portion thereof at a position axially outward than the first inner race side raceway surface;
an inner race that is fitted to the small diameter portion and includes a second inner race side raceway surface opposed to the second outer race side raceway surface;
a plurality of tapered rollers interposed between the first outer race side raceway surface and the first inner race side raceway surface and between the second outer race side raceway surface and the second inner race side raceway surface; and
a pulser ring that detects a rotation of the inner race and is fitted to the intermediate cylindrical surface.

2. The tapered roller bearing assembly according to claim 1 further comprising a seal that is attached to the radially inner side portion at an end thereof which faces a wheel, and protrudes radially inward.

3. A method of fabricating a tapered roller bearing assembly, the method comprising:
placing tapered rollers on a first outer race side raceway surface of an outer race;
fitting the outer ring to an inner shaft so that the first outer rare side raceway surface is opposed to a first inner race side raceway surface of the inner shaft and the tapered rollers are interposed between the first outer race side raceway surface and the first inner race side raceway surface;
after fitting the outer ring, fitting a pulser ring to an outer periphery of the inner shaft;
placing tapered rollers on a second inner race side raceway surface of an inner race; and
fitting the inner race to the inner shaft so that the second outer race side raceway surface is opposed to the second inner race side raceway surface, the tapered rollers are interposed between the second outer race side raceway surface and the second inner race side raceway surface and the pulser ring is disposed between the first inner race side raceway surface and the second inner race side raceway surface.

4. The method according to 3, wherein in the step of placing the tapered rollers on the first outer race side raceway surface, a seal is attached to a radially inner side portion of the outer race at an end thereof, and protrudes radially inward.
